(19) United States
(12) Patent Application Publication
(10) Pub. No.: US 2005/0152694 A1
(43) Pub. Date: Jul. 14, 2005

(54) Transmission of supervisory data in an optical communication system

(76) Inventor: David Chown, Ipswich (GB)

Correspondence Address: PERMAN & GREEN, 425 POST ROAD, FAIRFIELD, CT, 06824, US

(21) Appl. No.: 10/622,294

(22) Filed: Jul. 18, 2003

(30) Foreign Application Priority Data
Jul. 22, 2002 (EP) 02255113.9

(51) Int. Cl. H04B 10/08

(52) U.S. Cl. 398/30

(57) ABSTRACT

A system for converting a first and a second signal representative of payload and supervisory information, respectively, between an electrical format (PL, S) and a WDM optical format, includes:
a first converter (L1, P1) for converting the first signal between the electrical format (P, L) and a first disaggregated optical format,
a second converter (L2, P2) for converting the second signal between the electrical format (S) and a second disaggregated optical format, and an optical WDM converter (WDM-C, WDM-S) for converting the first and second signals between the aforesaid first and second disaggregated optical formats and the WDM aggregated optical format.

The first converter (L1, P1), the second converter (L2, P2) and the optical WDM converter (WDM-C, WDM-S) are integrated to a single self-contained module (TM1, RM1). The arrangement is adapted to be implemented as a transmitter, a receiver as well as a transceiver module.

### BACKGROUND OF THE INVENTION

1. Field of the Invention

The present invention relates to optical communication systems.

2. Brief Description of Related Developments

In an optical communication system, most of the data that is carried over the system is “payload” data, namely phone calls, e-mail, Internet messages, etc. A part of the data is “supervisory” data relating to operation of the system itself.

Supervisory data typically includes status and fault signals transmitted from network equipment at remote locations in the network to a central network control centre as well as command and control signals transmitted from the control centre to network equipment at remote locations.

Supervisory data is currently transmitted on a supervisory channel, at a wavelength distinct from the wavelength or wavelengths on which the payload data is transmitted.

Typically, for a system where payload data is transmitted over channels in the C band—namely 1525 to 1575 nm—the supervisory channel is at 1510, 1600 or 1300 nm.

Also typically, transmitters and receivers for the payload channel(s) and the supervisory channel are assembled from discrete laser and photodiode components with the combination and separation of the payload channels and the supervisory channel performed by a discrete WDM coupler/splitter device. These components have pigtails and are spliced together to perform the functions of launching, combining, separating and receiving the payload channels and the supervisory channel.

Additionally, electronics are required to drive the lasers in response to the digital payload and supervisory data inputs and to provide digital payload and supervisory data outputs in response to the signals provided by the photodiodes.

Recently, transmitter, receiver and transceiver modules have become available which, in systems not providing for the presence of supervisory channels, eliminate the need for splicing discrete components together and providing additional electronics by arranging all the required electric and optoelectronic components within a single housing with an electrical connector receiving a digital electrical signal and an optical connector receiving a patchcord. This simplifies the work of Network Equipment Manufactures (NEMs) as they no longer have to splice fibres and are no longer required to have a detailed knowledge of discrete lasers and photodiodes.

FIG. 1 shows an optical communication system of the prior art including a transmitter portion and a receiver portion shown at the top and bottom of the drawing, respectively.

The transmitter portion is intended to permit the transmission of digital data including payload data PL and supervisory data S over a system fibre SF.

The input payload data PL is fed to a laser drive electronics LD1 that drives a first laser source L1 to generate a first (payload) optical signal at a first wavelength.

Similarly, input data representing supervisory data S is fed to a further laser drive electronics LD2 that drives a second laser source L2 to generate a second optical signal at a second wavelength representative of supervisory data.

The optical signals representative of payload and supervisory data are combined in a WDM combiner WDM-C to be launched into the fibre SF. Splices S1 and S2 are provided between the laser sources L1 and L2 and the WDM combiner WDM-C.

A further splice S3 is provided between the combiner WDM-C and a first connector C1 (that is actually comprised of two complementary parts) for connection to the system fibre SF.

The receiver portion of the system has a structure that is substantially identical to the structure of the transmitter portion described in the foregoing.

The combined WDM optical signal coming from the system fibre SF is sent to a WDM splitter WDM-S. The optical wavelength carrying the payload signal and the optical wavelength carrying the supervisory signal are thus separated and sent towards a first photodetector P1 and a second photodetector P2, respectively.

The detected signals from the photodetectors P1 and P2 are fed to respective receiver electronics RE1 and RE2 to produce an output digital payload signal PL and an output digital supervisory signal S.

Again, at the receiver end of the system, a splice S4 is provided between the connector C2 associated at the receiving end of the system fibre SF and the WDM splitter WDM-S. Two additional splices S5 and S6 are arranged between the splitter WDM-S and photodetectors P1 and P2, respectively.

FIG. 2 shows another prior art solution wherein components identical or equivalent to those already shown and described in the foregoing are indicated with the same references as used in FIG. 1.

In the prior art arrangement of FIG. 2, the payload laser L1 and the associated laser driver electronic LD1 at the transmitting end, as well as the payload photodetector P1 and the associated receiver electronics RE1 at the receiving end of the system are integrated into transmitter and receiver modules indicated TM and RM, respectively.

Some of the splices of FIG. 1 (specifically those splices designated S1 and S5 in FIG. 1) are dispensed with. Splices such as splices S2, S3, S4, and S6 however still exist in the arrangement of FIG. 2 these splices having to be made and the fibre handled and secured.

At least in principle, it would be possible to integrate the supervisory laser L2 and the associated laser drive electronics LD2 as well as the supervisory photodetector P2 and the associated receiver electronics RE2 to form respective transmitter and receiver modules. However, such modules are not commercially available and, in any case, would not dispense with all the splicing and fibre handling considered.

It is therefore an object of this invention to devise an improved solution having the advantage of no longer having to splice fibres and wherein detailed knowledge of discrete lasers and photodiodes for use with supervisory channels is no longer required.

According to the present invention, such a solution is provided by means of the system having the features set forth in the claims that follow.

The concept of the invention as defined in the main claim distinctly encompasses a transmitter module, a receiver module as well as a transmitter/receiver (i.e. transceiver) module. It will thus be appreciated that referring to signals being converted between a given format and another format encompasses conversion in either direction, that is from said given format into said other format and vice versa.

### BRIEF DESCRIPTION OF THE DRAWINGS

The invention will now be described, by way of example only, with reference to the annexed drawings, wherein:

FIGS. 1 and 2, relating to prior art solutions, have been already described in the foregoing;

FIG. 3 shows a first embodiment of a system according to the invention;

FIG. 4, including portions designated 4a and 4b, respectively, shows typical arrangements for a transmitter module and receiver module for use in the invention; and

FIG. 5 shows a transceiver where the transmitter and receiver modules shown in FIGS. 4a and 4b are integrated to a single device.

### DETAILED DESCRIPTION OF THE PREFERRED EMBODIMENTS

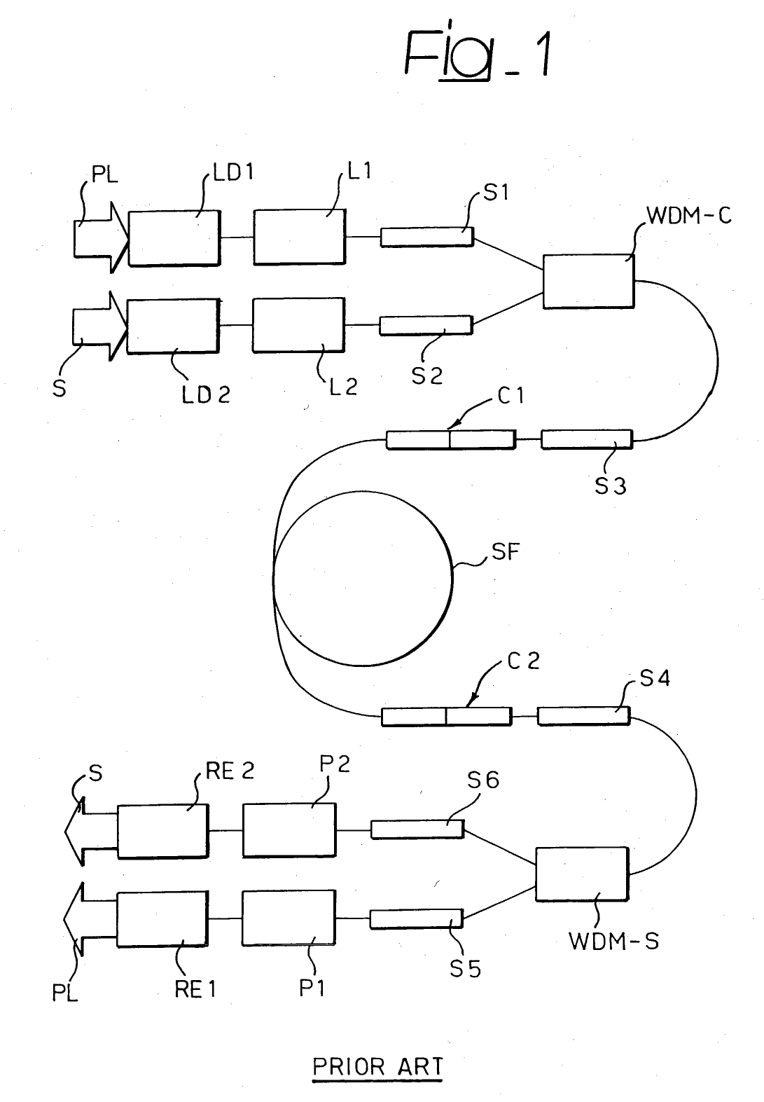

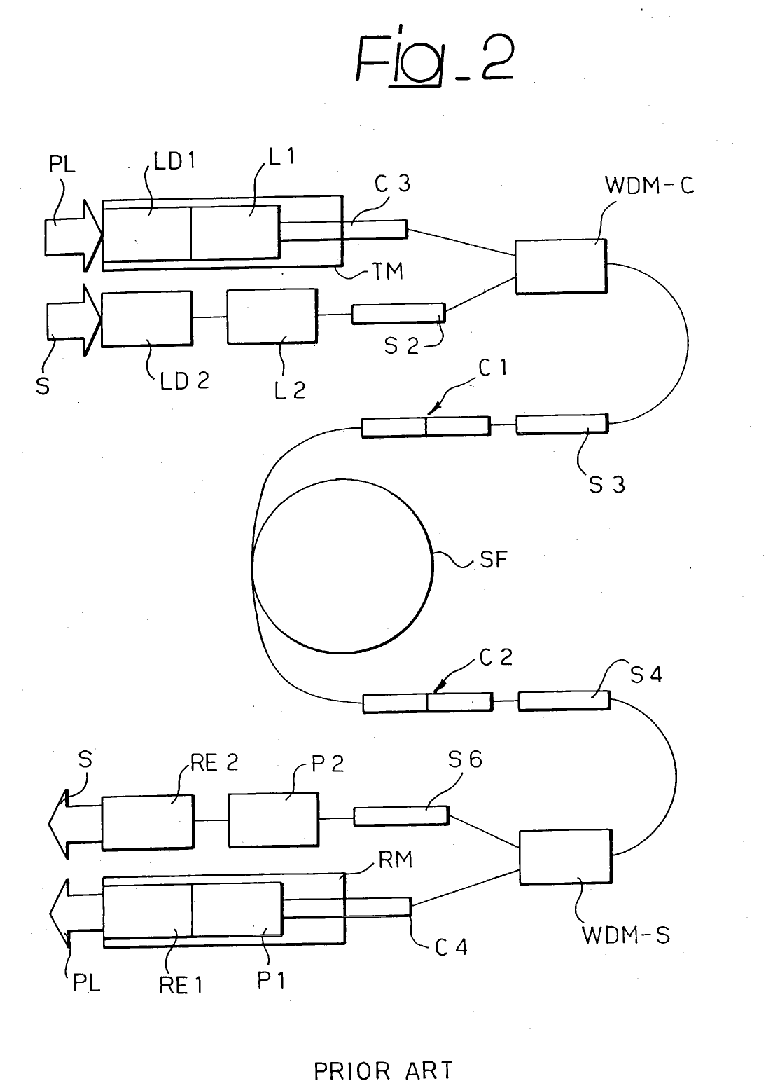

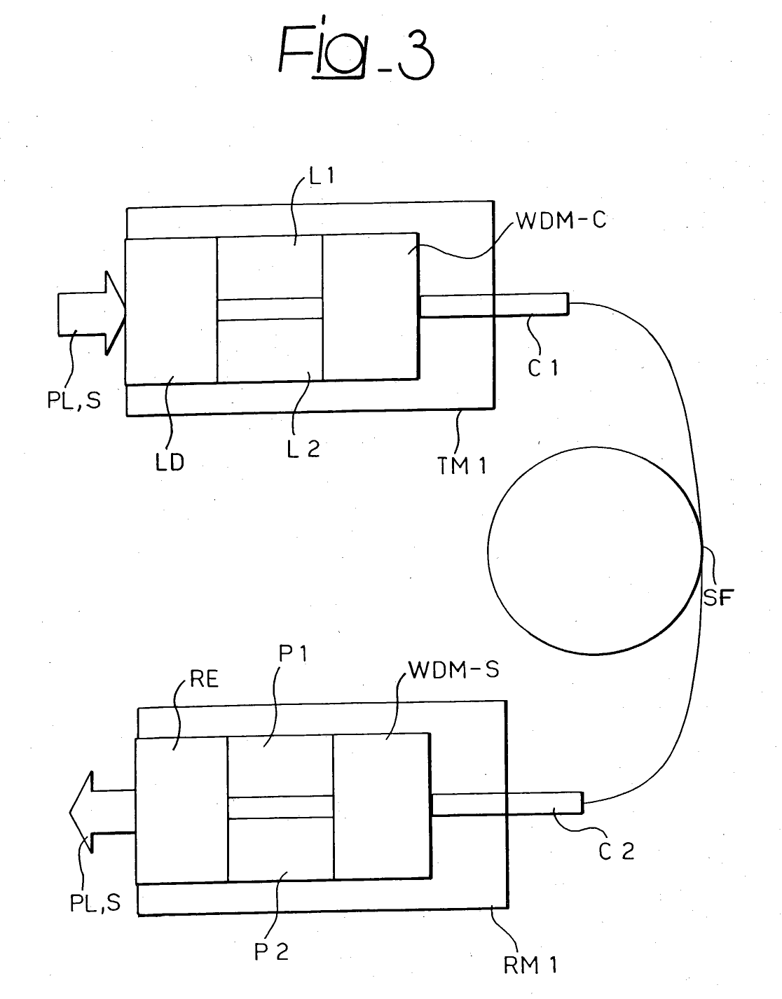

Again, in the drawings of FIGS. 3, 4 and 5 the same references were used to designate parts/components that are identical or, in any case, equivalent to those already described in connection with FIGS. 1 and 2.

This applies primarily to the system fibre SF, the connectors C1 and C2 associated therewith as well as the WDM combiner and splitter modules WDM-C and WDM-S. The combiner and splitter modules ensure conversion of the signal conveying both payload and supervisory information between an “aggregated” WDM signal format adopted for transmission over the system fibre SF and a “disaggregated” signal format, namely the format where payload and supervisory data are conveyed over distinct, separate optical signals i.e. before WDM multiplexing or after WDM de-multiplexing.

Similarly, references L1 and L2 designate respective laser sources adapted to generate respective “disaggregated” optical signals (i.e. before WDM multiplexing) corresponding to payload and supervisory information.

Finally, references P1 and P2 designate photodetectors intended to convert the “disaggregated” optical signals conveying the payload and supervisory information (i.e. after WDM de-multiplexing) back to the electrical format.

In the exemplary embodiment of the invention shown in FIG. 3, the payload and supervisory lasers L1, L2 as well as the respective (preferably common) drive electronics LD and the WDM combiner WDM-C are integrated into a single transmitter module TM1.

Similarly, the WDM de-multiplexer (splitter) unit WDM-S, the payload and supervisory photodetectors P1 and P2 together with the respective (again preferably common) electronics RE are similarly integrated into a single receiver module RM1.

Both modules TM1 and RM1 are self-contained modules adapted for direct connection (on the optical side) to the system fibre SF via connectors C1, C2, where all the splices provided in the prior art arrangements shown in FIGS. 1 and 2 having been dispensed with. Stated otherwise, the components included in the modules TM1 and RM1 are connected by means of signal propagation paths that are exempt from splices.

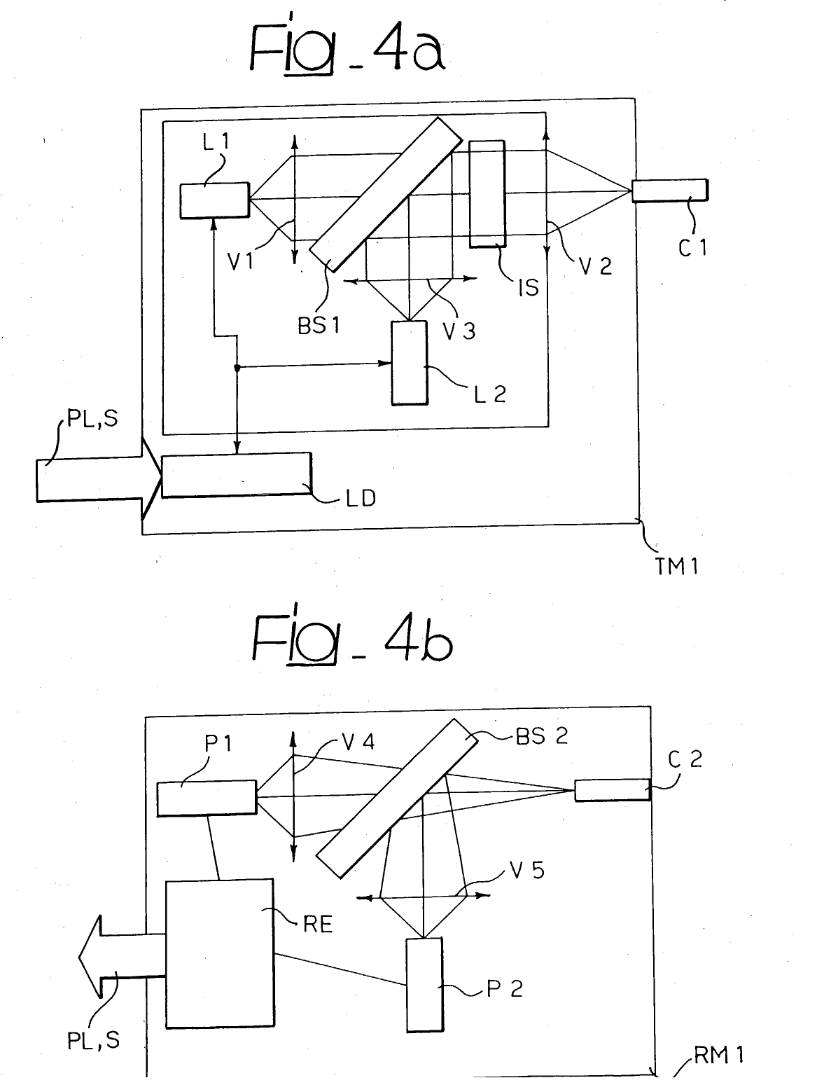

FIG. 4a shows in greater detail the structure of the “optical” portion of the transmitter module TM1.

Light from the payload laser L1 is collimated by a lens V1, shown conventionally as a double headed arrow, and transmitted through a beam splitter BS1 and an optional isolator IS before being focussed into the connector C1 (comprised, for example, of a fibre stub) by a second lens V2.

Light from the supervisory laser L2 is similarly collimated by a third lens V3 and reflected by the beam splitter BS1 to be transmitted through the optional isolator before being focussed into the connector by the second lens V2.

At least one of the payload laser L1, supervisory laser L2, beam splitter BS1 and isolator IS may be mounted on a thermoelectric cooler (e.g. a Peltier-effect module) in a hermetic enclosure.

The laser drive electronics LD are typically mounted on a printed circuit board within the module housing. The electrical and optical connectors are mounted on the module housing.

FIG. 4b shows the receiver module RM1 having a substantially similar structure.

Light from the connector R2 is incident on a beam splitter BS2. Light in the payload channel is transmitted through the beam splitter BS2 and focussed via a lens V4 onto the payload photodetector P1.

Light in the supervisory channel is reflected by the beam splitter and is focussed by a lens V5 onto the supervisory photodetector P2.

Again, the receiver electronics RE are mounted on a printed circuit board within the module housing. The electrical and optical connectors are mounted on the module housing.

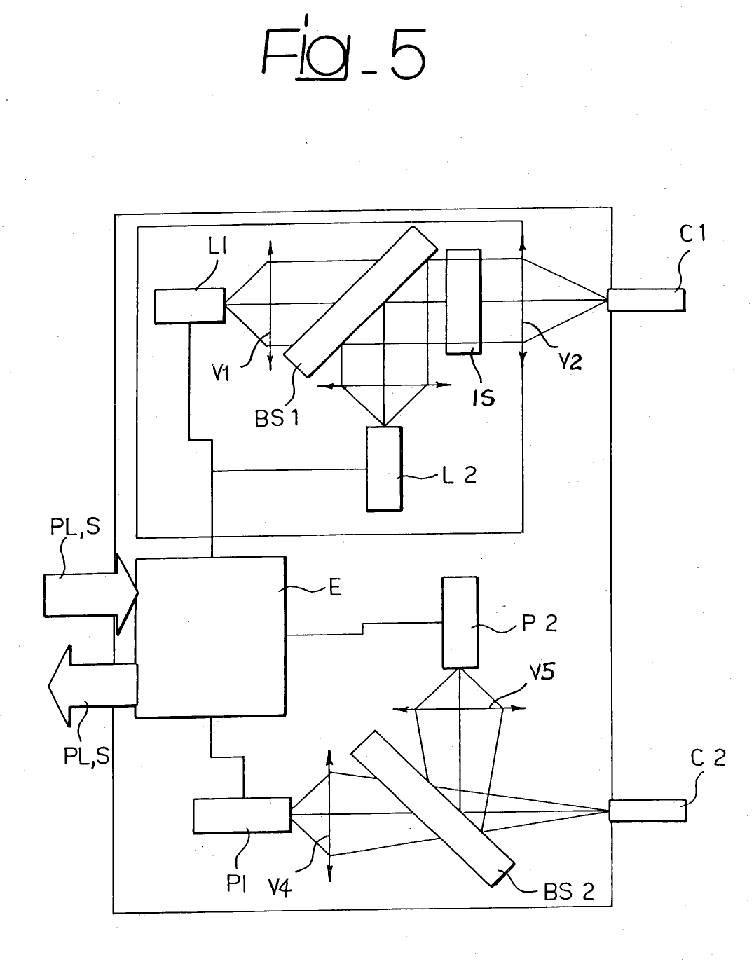

FIG. 5 shows a transmitter-receiver i.e. transceiver module in which the transmitter and receiver functions of FIGS. 4a and 4b are integrated into a single housing. Such an arrangement provides the additional advantage of the laser drive electronics LD and receiver electronics RE being adapted to be integrated to a single electronics sub-module designated E.

Of course, without prejudice to the basic principle of the invention, the details of construction and the embodiments may widely vary with respect to what has been described and illustrated purely by way of example, without departing from the scope of the present invention. Also, it will be appreciated that, according to the current meaning in the art, designations such as “optical”, “light” and so on are in no way restricted to the sole domain of visible light radiation. These designations do in fact apply to the whole of the wavelength domains adapted for use in optical communications, including e.g. the UV and IR domains.

1. A system for converting a first and a second signal representative of payload and supervisory information, respectively, between an electrical format and a WDM aggregated optical format, the system including:
at least one first converter for converting said first signal between said electrical format and a first, disaggregated optical format,
at least one second converter for converting said second signal between said electrical format and a second, disaggregated optical format, and
at least one optical WDM converter for converting said first and second signals between said first and second disaggregated optical formats and said WDM aggregated optical format,
characterised in that said at least one first converter, said at least one second converter and said at least one optical WDM converter are integrated to a single self-contained module by means of signal propagation paths that are exempt from splices.

2. The system of claim 1, characterised in that said first converter and said second converter have associated signal processing electronics, said signal processing electronics being integrated to said single self-contained module.

3. The system of claim 1, characterised in that said optical WDM converter includes a beam splitter.

4. The system of claim 3, characterised in that said beam splitter has associated an optical connector for conveying said first and said second signals in said WDM aggregated optical format, and in that said beam splitter is arranged to transfer optical radiation between said first converter and said optical connector.

5. The system of claim 3, characterised in that said beam splitter has associated an optical connector for conveying said first and said second signals in said WDM aggregated optical format, and in that said beam splitter is arranged to define an optical signal reflection path between said second converter and said optical connector.

6. The system of claim 3, characterised in that said beam splitter has associated radiation focusing elements interposed between said beam splitter and said first and said second converter.

7. The system of claim 4, characterised in that it includes a further focusing element interposed between said beam splitter and said optical connector for focusing onto said optical connector optical radiation propagating from said beam splitter.

8. The system of claim 7, characterised in that it includes an optical isolator interposed between said beam splitter and said further focusing element.

9. The system of claim 1, characterised in that said first converter and said second converter include laser sources driven with said first and second signals in said electrical format, respectively, and in that said optical WDM converter includes a WDM combiner to combine said first and said second signals in said first disaggregated optical format and said second disaggregated optical format to produce said WDM aggregated optical format, the system thus comprising a transmitter module.

10. The system of claim 1, characterised in that said optical WDM converter includes a WDM splitter for de-multiplexing said WDM aggregated optical format into said first disaggregated optical format and said second disaggregated optical format, and in that said first converter and said second converter include photoelectric converters for converting said first disaggregated optical format and said second disaggregated optical format into said first and second signals in said electrical format, the system thus comprising a receiver module.

11. The system of claim 1, characterised in that it includes:
A pair of said first converters, in the form of a first laser source and a first photoelectric converter, respectively;
a pair of said second converters in the form of a second laser source and a second photoelectric converter, respectively; and
a pair of said optical WDM converters, in the form of a WDM combiner and a WDM splitter, respectively;
the arrangement being such that said first laser source and said second laser source are arranged for converting a first pair of first and second signals representative of payload and supervisory information, respectively, from said electrical format into a first pair of first disaggregated optical format and second disaggregated optical format signals and said WDM combiner is adapted to convert said first pair of first and second disaggregated optical format signals into a first WDM aggregated optical format signal, and
said WDM splitter is adapted to convert a second WDM aggregated optical format signal into a second pair of first and second disaggregated optical format signals, and said first photoelectric converter and said second photoelectric converter are adapted to convert said second pair of first and second disaggregated optical format signals into a second pair of first and second signals representative of payload and supervisory information in said electrical format, the system thus comprising a transceiver module.
